(19) United States
(12) Patent Application Publication
(10) Pub. No.: US 2016/0044339 A1
(43) Pub. Date: Feb. 11, 2016

(54) SYSTEM AND METHOD FOR REORDERING OF PREFIXES AND SUFFIXES IN VARIABLE LENGTH CODING TO INCREASE THROUGHPUT

(71) Applicant: QUALCOMM Incorporated, San Diego, CA (US)

(72) Inventor: Clara Ka Wah SUNG, Markham (CA)

(21) Appl. No.: 14/820,449

(22) Filed: Aug. 6, 2015

Related U.S. Application Data
(60) Provisional application No. 62/034,660, filed on Aug. 7, 2014.

(51) Int. Cl. H04N 19/91; H04N 19/186; H04N 19/182; H04N 19/13; H04N 19/167

(52) U.S. Cl. CPC H04N 19/91; H04N 19/13; H04N 19/167; H04N 19/182; H04N 19/186

(57) ABSTRACT

According to certain aspects, an apparatus for decoding video data includes a memory and a processor configured to: receive a bitstream including a plurality of prefixes and a plurality of suffixes associated with the plurality of prefixes, the plurality of prefixes and the plurality of suffixes used in variable length coding (VLC), each of the plurality of prefixes indicative of a length of one or more of the plurality of suffixes, each of the plurality of suffixes representing a color component of a pixel in a block, the block including a plurality of pixels, wherein all of the plurality of prefixes precede all of the plurality of suffixes; decode at least some of the plurality of prefixes; and subsequent to decoding at least some of the plurality of prefixes, decode at least some of the plurality of suffixes associated with the at least some of the plurality of prefixes.

### INCORPORATION BY REFERENCE TO PRIORITY APPLICATIONS

This application claims the benefit of U.S. Provisional Application No. 62/034,660, filed Aug. 7, 2014, which is incorporated by reference in its entirety. Any and all applications for which a foreign or domestic priority claim is identified in the Application Data Sheet as filed with the present application are hereby incorporated by reference under 37 CFR 1.57.

### TECHNICAL FIELD

This disclosure relates to the field of video coding and compression, and particularly to video compression for transmission over display links, such as display link video compression.

### BACKGROUND

Digital video capabilities can be incorporated into a wide range of displays, including digital televisions, personal digital assistants (PDAs), laptop computers, desktop monitors, digital cameras, digital recording devices, digital media players, video gaming devices, video game consoles, cellular or satellite radio telephones, video teleconferencing devices, and the like. Display links are used to connect displays to appropriate source devices. The bandwidth requirements of display links are proportional to the resolution of the displays, and thus, high-resolution displays require large bandwidth display links. Some display links do not have the bandwidth to support high resolution displays. Video compression can be used to reduce the bandwidth requirements such that lower bandwidth display links can be used to provide digital video to high resolution displays.

Others have tried to utilize image compression on the pixel data. However, such schemes are sometimes not visually lossless or can be difficult and expensive to implement in conventional display devices.

The Video Electronics Standards Association (VESA) has developed Display Stream Compression (DSC) as a standard for display link video compression. The display link video compression technique, such as DSC, should provide, among other things, picture quality that is visually lossless (i.e., pictures having a level of quality such that users cannot tell the compression is active). The display link video compression technique should also provide a scheme that is easy and inexpensive to implement in real-time with conventional hardware.

### SUMMARY

The systems, methods and devices of this disclosure each have several innovative aspects, no single one of which is solely responsible for the desirable attributes disclosed herein.

In one aspect, an apparatus for coding video data includes a memory for storing the video data and a processor. The processor is configured to receive a bitstream including a plurality of prefixes and a plurality of suffixes associated with the plurality of prefixes, the plurality of prefixes and the plurality of suffixes used in variable length coding (VLC), each of the plurality of prefixes indicative of a length of one or more of the plurality of suffixes, each of the plurality of suffixes representing a color component of a pixel in a block of the video data, the block including a plurality of pixels, wherein all of the plurality of prefixes precede all of the plurality of suffixes. The processor is further configured to decode at least some of the plurality of prefixes. The processor is additionally configured to, subsequent to decoding at least some of the plurality of prefixes, decode at least some of the plurality of suffixes associated with the at least some of the plurality of prefixes.

In another aspect, a method of coding video data includes: storing the video data; receiving a bitstream including a plurality of prefixes and a plurality of suffixes associated with the plurality of prefixes, the plurality of prefixes and the plurality of suffixes used in variable length coding (VLC), each of the plurality of prefixes indicative of a length of one or more of the plurality of suffixes, each of the plurality of suffixes representing a color component of a pixel in a block, the block including a plurality of pixels, wherein all of the plurality of prefixes precede all of the plurality of suffixes; decoding the plurality of prefixes; and subsequent to decoding the plurality of prefixes, decoding the plurality of suffixes.

In yet another aspect, a non-transitory computer readable medium comprising instructions that when executed on a processor comprising computer hardware cause the processor to: store the video data; receive a bitstream including a plurality of prefixes and a plurality of suffixes associated with the plurality of prefixes, the plurality of prefixes and the plurality of suffixes used in variable length coding (VLC), each of the plurality of prefixes indicative of a length of one or more of the plurality of suffixes, each of the plurality of suffixes representing a color component of a pixel in a block, the block including a plurality of pixels, wherein all of the plurality of prefixes precede all of the plurality of suffixes; decode the plurality of prefixes; and subsequent to decoding the plurality of prefixes, decode the plurality of suffixes.

In one aspect, an apparatus for coding video information comprises: means for storing the video data; means for receiving a bitstream including a plurality of prefixes and a plurality of suffixes associated with the plurality of prefixes, the plurality of prefixes and the plurality of suffixes used in variable length coding (VLC), each of the plurality of prefixes indicative of a length of one or more of the plurality of suffixes, each of the plurality of suffixes representing a color component of a pixel in a block, the block including a plurality of pixels, wherein all of the plurality of prefixes precede all of the plurality of suffixes; means for decoding the plurality of prefixes; and means for decoding the plurality of suffixes, subsequent to decoding the plurality of prefixes.

### BRIEF DESCRIPTION OF THE DRAWINGS

FIG. 1A is a block diagram illustrating an example video encoding and decoding system that may utilize techniques in accordance with aspects described in this disclosure.

FIG. 1B is a block diagram illustrating another example video encoding and decoding system that may perform techniques in accordance with aspects described in this disclosure.

FIG. 2A is a block diagram illustrating an example of a video encoder that may implement techniques in accordance with aspects described in this disclosure.

FIG. 2B is a block diagram illustrating an example of a video decoder that may implement techniques in accordance with aspects described in this disclosure.

FIG. 3 is a block diagram illustrating an example of a bitstream using VLC.

FIG. 4 is a block diagram illustrating an example of hardware implementation for decoding a bitstream using VLC.

FIG. 5 is a block diagram illustrating an example of a bitstream used in VLC for ordering prefixes and suffixes in accordance with aspects described in this disclosure.

FIG. 6 is a block diagram illustrating an example of hardware implementation for decoding a bitstream used in VLC for ordering prefixes and suffixes in accordance with aspects described in this disclosure.

FIG. 7 is a block diagram illustrating an example of hardware implementation for decoding a bitstream used in VLC for ordering prefixes and suffixes in accordance with aspects described in this disclosure.

FIG. 8 is a block diagram illustrating an example of decoding a bitstream used in VLC for ordering prefixes and suffixes in accordance with aspects described in this disclosure.

FIG. 9 is a flowchart illustrating a method for ordering prefixes and suffixes in VLC in accordance with aspects described in this disclosure.

### DETAILED DESCRIPTION

In general, this disclosure relates to methods of improving video compression techniques such as those utilized in display link video compression. More specifically, the present disclosure relates to systems and methods for ordering prefixes and suffixes in a variable length coding to increase throughput.

While certain embodiments are described herein in the context of the DSC standard, one having ordinary skill in the art would appreciate that systems and methods disclosed herein may be applicable to any suitable video coding standard. For example, embodiments disclosed herein may be applicable to one or more of the following standards: International Telecommunication Union (ITU) Telecommunication Standardization Sector (ITU-T) H.261, International Organization for Standardization/International Electrotechnical Commission (ISO/IEC) Moving Picture Experts Group-1 (MPEG-1) Visual, ITU-T H.262 or ISO/IEC MPEG-2 Visual, ITU-T H.263, ISO/IEC MPEG-4 Visual, ITU-T H.264 (also known as ISO/IEC MPEG-4 AVC), High Efficiency Video Coding (HEVC), and any extensions to such standards. Also, the techniques described in this disclosure may become part of standards developed in the future. In other words, the techniques described in this disclosure may be applicable to previously developed video coding standards, video coding standards currently under development, and forthcoming video coding standards.

A proposed methodology for the DSC standard includes a number of coding modes in which each block of video data may be encoded by an encoder and, similarly, decoded by a decoder.

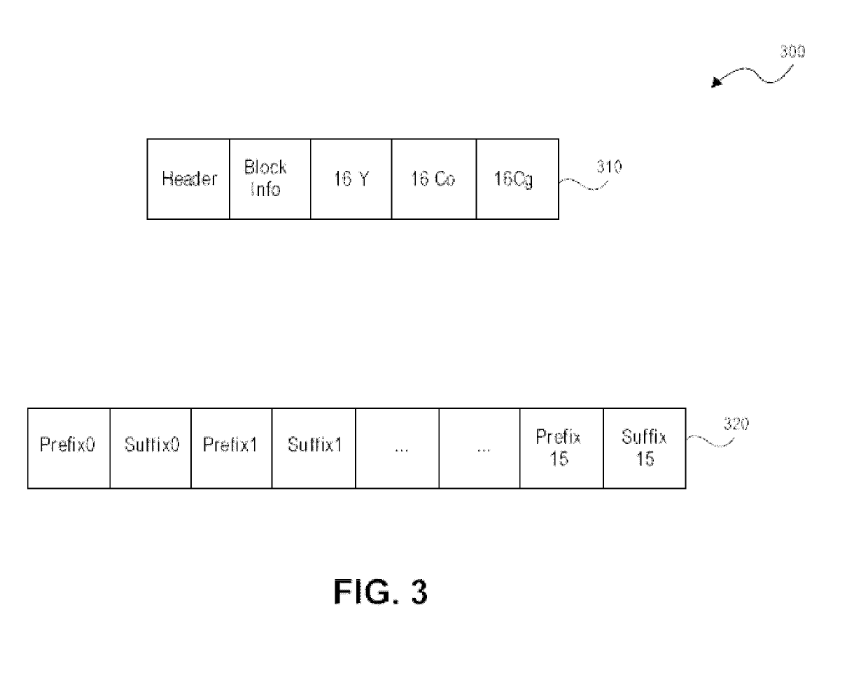

Variable length coding (VLC) may be used to code video data in DSC. Numerous VLC techniques divide each symbol into a prefix and a suffix. The length of the suffix may be fixed (e.g., Golomb Rice codes) or may depend on the prefix value (e.g., exponential Golomb codes). The prefix value may specify the length of the suffix. For example, a prefix can indicate the length of a suffix, where the suffix indicates the value of a color component of a pixel. A color component can include a luminance component and one or chrominance components. For instance, in YCgCo color model (or YCoCg color model), a pixel is represented by a luminance component (Y), a chrominance green component (Cg), and a chrominance orange component (Co). A DSC bitstream may include a prefix for a color component of each pixel and a suffix for that color component. For example, a block may be coded in units of 16 pixels, and the DSC bitstream can include a prefix and a suffix for the Y component of each pixel, a prefix and a suffix for the Cg component of each pixel, and a prefix and a suffix for the Co component of each pixel. The order of the prefixes and suffixes can be arranged such that the prefixes and the suffixes alternate. For example, the prefix and the suffix of a color component (e.g., Y component) of the first pixel are encoded first, then the prefix and the suffix of the same color component of the second pixel is encoded, and so on. All prefix and suffix pairs for the same color component can be grouped together. For instance, the prefix and suffix pairs for the Y component are grouped together, then the prefix and suffix pairs for the Cg component, and then the prefix and suffix pairs for the Co component, as shown in FIG. 3.

However, alternating the prefix and the suffix in this manner may make it difficult to meet throughput requirements because each prefix and suffix pair is decoded in sequence. The decoder may not have information on where the second prefix is located in the bitstream until the decoder decodes the first prefix and then decodes the first suffix based on the length indicated by the first prefix. This can create a cascading path which makes it difficult to meet timing, thereby decreasing the throughput. Moreover, in some cases, since the prefix is typically coded using a unary code, the length of the prefix may be variable. Therefore, a decoder should parse the prefix before the decoder can start parsing the suffix, since the starting position of the suffix depends on the length of the prefix.

In order to address these and other challenges, the techniques according to certain aspects of the present disclosure can reorder the prefixes and suffixes representing pixels to increase throughput, for example, by placing all prefixes in front of all suffixes. Placing all prefixes before all suffixes can allow parallel decoding of suffixes because the length of some or all suffixes can be obtained by beginning to decodeone or more prefixes first (i.e., decoding one or more prefixes prior to beginning decoding of the suffixes). The decoder then can determine the position of one or more suffixes after decoding one or more prefixes, and therefore decoding of the suffixes (for example, for which the length is known) can proceed in parallel. In one example, all prefixes for the Y component of the pixels in a block precede all suffixes for the Y component of the pixels in the block. Making the prefixes available prior to the suffixes can make the decoding process more efficient since the suffixes can be decoded in parallel and can increase throughput.

### Video Coding Standards

A digital image, such as a video image, a TV image, a still image or an image generated by a video recorder or a computer, may include pixels or samples arranged in horizontal and vertical lines. The number of pixels in a single image is typically in the tens of thousands. Each pixel typically contains luminance and chrominance information. Without compression, the sheer quantity of information to be conveyed from an image encoder to an image decoder would render real-time image transmission impractical. To reduce the amount of information to be transmitted, a number of different compression methods, such as JPEG, MPEG and H.263 standards, have been developed.

Video coding standards include ITU-T H.261, ISO/IEC MPEG-1 Visual, ITU-T H.262 or ISO/IEC MPEG-2 Visual, ITU-T H.263, ISO/IEC MPEG-4 Visual, ITU-T H.264 (also known as ISO/IEC MPEG-4 AVC), and HEVC including extensions of such standards.

In addition, a video coding standard, namely DSC, has been developed by VESA. The DSC standard is a video compression standard which can compress video for transmission over display links. As the resolution of displays increases, the bandwidth of the video data required to drive the displays increases correspondingly. Some display links may not have the bandwidth to transmit all of the video data to the display for such resolutions. Accordingly, the DSC standard specifies a compression standard for interoperable, visually lossless compression over display links.

The DSC standard is different from other video coding standards, such as H.264 and HEVC. DSC includes intra-frame compression, but does not include inter-frame compression, meaning that temporal information may not be used by the DSC standard in coding the video data. In contrast, other video coding standards may employ inter-frame compression in their video coding techniques.

### Video Coding System

Various aspects of the novel systems, apparatuses, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of, or combined with, any other aspect of the present disclosure. For example, an apparatus may be implemented or a method may be practiced using any number of the aspects set forth herein. In addition, the scope of the present disclosure is intended to cover such an apparatus or method which is practiced using other structure, functionality, or structure and functionality in addition to or other than the various aspects of the present disclosure set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The attached drawings illustrate examples. Elements indicated by reference numbers in the attached drawings correspond to elements indicated by like reference numbers in the following description. In this disclosure, elements having names that start with ordinal words (e.g., “first,” “second,” “third,” and so on) do not necessarily imply that the elements have a particular order. Rather, such ordinal words are merely used to refer to different elements of a same or similar type.

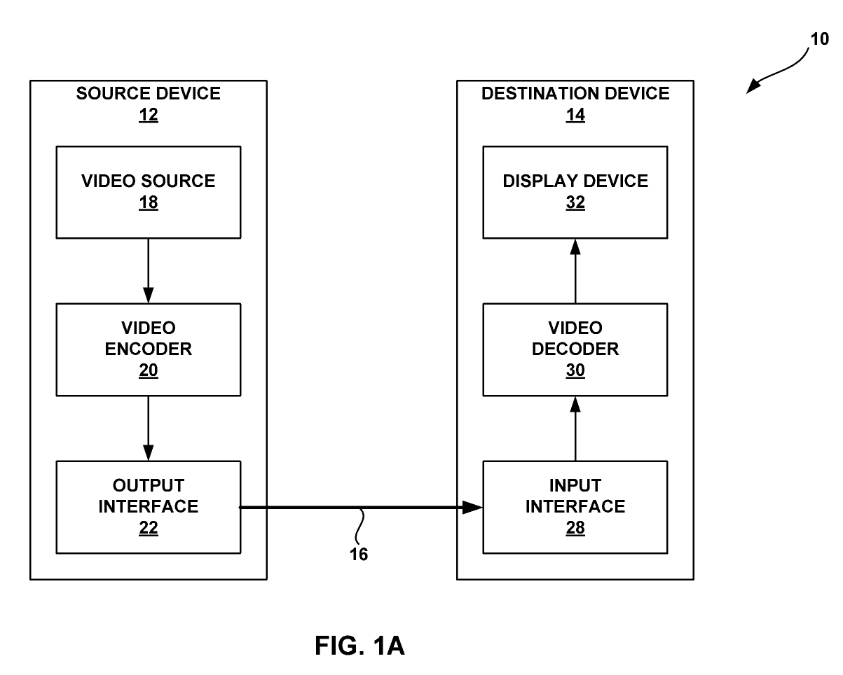

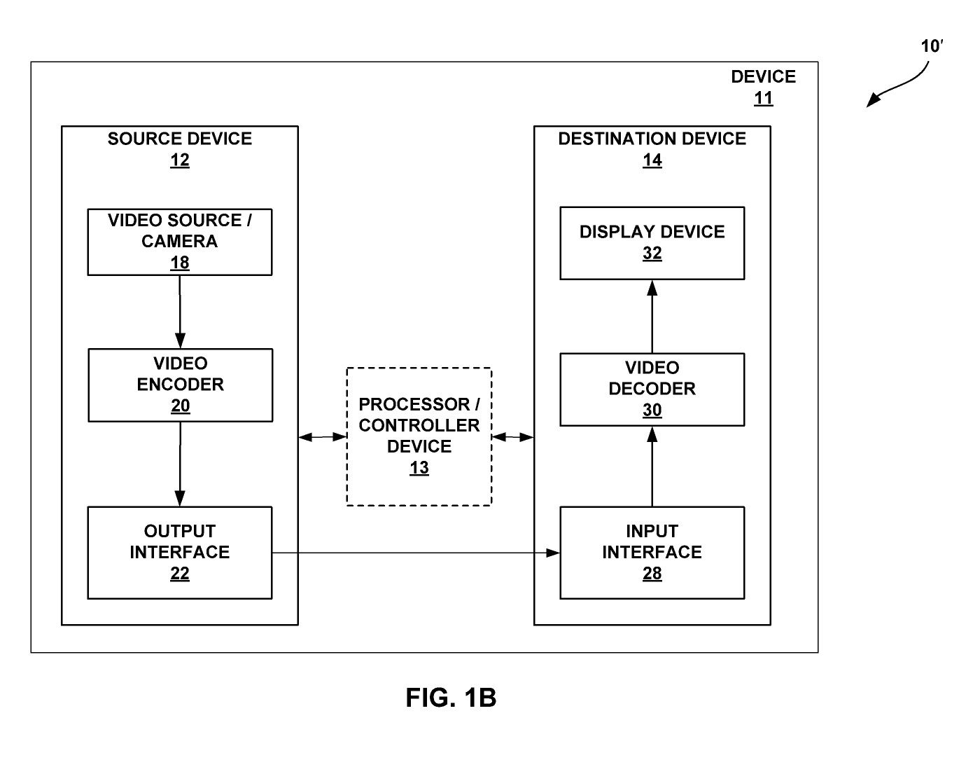

FIG. 1A is a block diagram that illustrates an example video coding system 10 that may utilize techniques in accordance with aspects described in this disclosure. As used described herein, the term “video coder” or “coder” refers generically to both video encoders and video decoders. In this disclosure, the terms “video coding” or “coding” may refer generically to video encoding and video decoding. In addition to video encoders and video decoders, the aspects described in the present application may be extended to other related devices such as transcoders (e.g., devices that can decode a bitstream and re-encode another bitstream) and middleboxes (e.g., devices that can modify, transform, and/or otherwise manipulate a bitstream).

As shown in FIG. 1A, video coding system 10 includes a source device 12 (i.e., “video coding device 12” or “coding device 12”) that generates encoded video data to be decoded at a later time by a destination device 14 (i.e., “video coding device 14” or “coding device 14”). In the example of FIG. 1A, the source device 12 and destination device 14 constitute separate devices. It is noted, however, that the source device 12 and destination device 14 may be on or part of the same device, as shown in the example of FIG. 1B.

With reference once again, to FIG. 1A, the source device 12 and the destination device 14 may respectively comprise any of a wide range of devices (also referred to as video coding devices) including desktop computers, notebook (e.g., laptop) computers, tablet computers, set-top boxes, telephone handsets such as so-called “smart” phones, so-called “smart” pads, televisions, cameras, display devices, digital media players, video gaming consoles, video streaming device, or the like. In various embodiments, the source device 12 and the destination device 14 may be equipped for (i.e., configured to communicate via) wireless communication.

The video coding devices 12, 14 of the video coding system 10 may be configured to communicate via wireless networks and radio technologies, such as wireless wide area network (WWAN) (e.g., cellular) and/or wireless local area network (WLAN) carriers. The terms “network” and “system” are often used interchangeably. Each of the video coding devices 12, 14 may be a user equipment (UE), a wireless device, a terminal, a mobile station, a subscriber unit, etc.

The WWAN carriers may include, for example, wireless communication networks such as Code Division Multiple Access (CDMA), Time Division Multiple Access (TDMA), Frequency Division Multiple Access (FDMA), Orthogonal FDMA (OFDMA), Single-Carrier FDMA (SC-FDMA) and other networks. A CDMA network may implement a radio technology such as Universal Terrestrial Radio Access (UTRA), CDMA2000, etc. UTRA includes Wideband CDMA (WCDMA) and other variants of CDMA. CDMA2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A and GSM are described in documents from an organization named “3rd Generation Partnership Project” (3GPP). CDMA2000 and UMB are described in documents from an organization named “3rd Generation Partnership Project 2” (3GPP2).

The video coding devices 12, 14 of the video coding system 10 may also communicate with each over via a WLAN base station according to one or more standards, such as the IEEE 802.11 standard, including, for example these amendments: 802.11a-1999 (commonly called “802.11a”), 802.11b-1999 (commonly called “802.11b”), 802.11g-2003 (commonly called “802.11g”), and so on.

The destination device 14 may receive, via link 16, the encoded video data to be decoded. The link 16 may comprise any type of medium or device capable of moving the encoded video data from the source device 12 to the destination device 14. In the example of FIG. 1A, the link 16 may comprise a communication medium to enable the source device 12 to transmit encoded video data to the destination device 14 in real-time. The encoded video data may be modulated according to a communication standard, such as a wireless communication protocol, and transmitted to the destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from the source device 12 to the destination device 14.

In the example of FIG. 1A, the source device 12 includes a video source 18, video encoder 20 and the output interface 22. In some cases, the output interface 22 may include a modulator/demodulator (modem) and/or a transmitter. In the source device 12, the video source 18 may include a source such as a video capture device, e.g., a video camera, a video archive containing previously captured video, a video feed interface to receive video from a video content provider, and/or a computer graphics system for generating computer graphics data as the source video, or a combination of such sources. As one example, if the video source 18 is a video camera, the source device 12 and the destination device 14 may form so-called “camera phones” or “video phones”, as illustrated in the example of FIG. 1B. However, the techniques described in this disclosure may be applicable to video coding in general, and may be applied to wireless and/or wired applications.

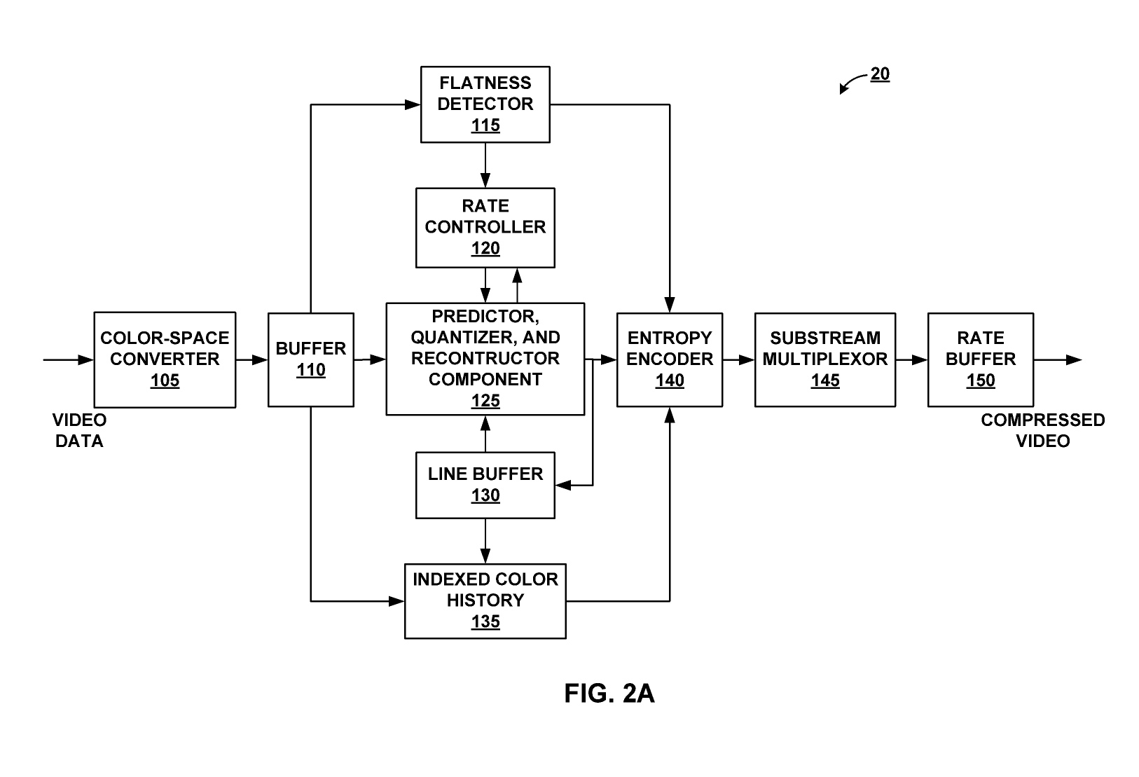

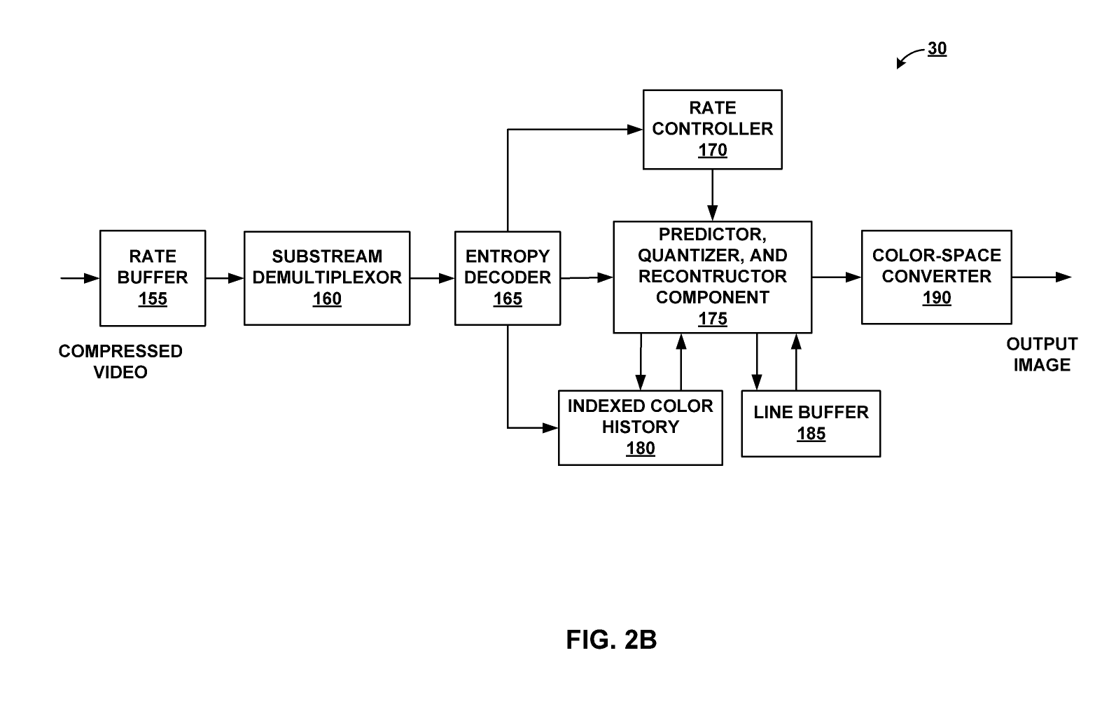

The captured, pre-captured, or computer-generated video may be encoded by the video encoder 20. The encoded video data may be transmitted to the destination device 14 via the output interface 22 of the source device 12. The encoded video data may also (or alternatively) be stored onto a storage device (not illustrated) for later access by the destination device 14 or other devices, for decoding and/or playback. The video encoder 20 illustrated in FIG 1A and 1B may comprise the video encoder 20 illustrated FIG. 2A or any other video encoder described herein.

In the example of FIG. 1A, the destination device 14 includes the input interface 28, a video decoder 30, and a display device 32. In some cases, the input interface 28 may include a receiver and/or a modem. The input interface 28 of the destination device 14 may receive the encoded video data over the link 16 and/or from the storage device. The encoded video data communicated over the link 16, or provided on the storage device, may include a variety of syntax elements generated by the video encoder 20 for use by a video decoder, such as the video decoder 30, in decoding the video data. Such syntax elements may be included with the encoded video data transmitted on a communication medium, stored on a storage medium, or stored a file server. The video decoder 30 illustrated in FIG. 1A and 1B may comprise the video decoder 30 illustrated in FIG. 2B or any other video decoder described herein.

The display device 32 may be integrated with, or external to, the destination device 14. In some examples, the destination device 14 may include an integrated display device and also be configured to interface with an external display device. In other examples, the destination device 14 may be a display device. In general, the display device 32 displays the decoded video data to a user, and may comprise any of a variety of display devices such as a liquid crystal display (LCD), a plasma display, an organic light emitting diode (OLED) display, or another type of display device.

In related aspects, FIG. 1B shows an example video coding system 10′ wherein the source device 12 and the destination device 14 are on or part of a device 11. The device 11 may be a telephone handset, such as a “smart” phone or the like. The device 11 may include a processor/controller device 13 (optionally present) in operative communication with the source device 12 and the destination device 14. The video coding system 10′ of FIG. 1B, and components thereof, are otherwise similar to the video coding system 10 of FIG. 1A, and components thereof.

Although each of FIGS. 1A and 1B show that the source device 12 includes the video source/camera 18, the video encoder 20, and the output interface 22 and the destination device 14 includes the input interface 28, the video decoder 30, and the display device 32, each of the source and destination devices 12 and 14 may include additional elements. For example, each of the source and destination devices 12 and 14 may have a similar structure including the video source/camera 18, the video encoder 20, the output interface 22, the input interface 28, the video decoder 30, and the display device 32. As such, in certain implementations the source and destination devices 12 and 14 may be interchangeable.

The video encoder 20 and the video decoder 30 may operate according to a video compression standard, such as DSC. Alternatively, the video encoder 20 and the video decoder 30 may operate according to other proprietary or industry standards, such as the ITU-T H.264 standard, alternatively referred to as MPEG-4, Part 10, AVC, HEVC or extensions of such standards. The techniques of this disclosure, however, are not limited to any particular coding standard. Other examples of video compression standards include MPEG-2 and ITU-T H.263.

Although not shown in the examples of FIGS. 1A and 1B, the video encoder 20 and the video decoder 30 may each be integrated with an audio encoder and decoder, and may include appropriate MUX-DEMUX units, or other hardware and software, to handle encoding of both audio and video in a common data stream or separate data streams. If applicable, in some examples, MUX-DEMUX units may conform to the ITU H.223 multiplexer protocol, or other protocols such as the user datagram protocol (UDP).

The video encoder 20 and the video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of the video encoder 20 and the video decoder 30 may be included in one or more encoders or decoders, either of which may be integrated as part of a combined encoder/decoder in a respective device.

### Video Coding Process

As mentioned briefly above, the video encoder 20 encodes video data. The video data may comprise one or more pictures. Each of the pictures is a still image forming part of a video. In some instances, a picture may be referred to as a video “frame.” When the video encoder 20 encodes the video data (e.g., video coding layer (VCL) data and/or non-VCL data), the video encoder 20 may generate a bitstream. The bitstream may include a sequence of bits that form a coded representation of the video data. The bitstream may include coded pictures and associated data. A coded picture is a coded representation of a picture. VCL data may include coded picture data (i.e., information associated with samples of a coded picture(s)) and non-VCL data may include control information (e.g., parameter sets and/or supplemental enhancement information) associated with the one or more coded pictures.

To generate the bitstream, the video encoder 20 may perform encoding operations on each picture in the video data. When the video encoder 20 performs encoding operations on the pictures, the video encoder 20 may generate a series of coded pictures and associated data. The associated data may include a set of coding parameters such as a quantization parameter (QP). To generate a coded picture, the video encoder 20 may partition a picture into equally-sized video blocks. A video block may be a two-dimensional array of samples. The coding parameters may define a coding option (e.g., a coding mode) for every block of the video data. The coding option may be selected in order to achieve a desired rate-distortion performance.

In some examples, the video encoder 20 may partition a picture into a plurality of slices. Each of the slices may include a spatially distinct region in an image (e.g., a frame) that can be decoded independently without information from the rest of the regions in the image or frame. Each image or video frame may be encoded in a single slice or each image or video frame may be encoded in several slices. In DSC, the number of bits allocated to encode each slice may be substantially constant. As part of performing an encoding operation on a picture, the video encoder 20 may perform encoding operations on each slice of the picture. When the video encoder 20 performs an encoding operation on a slice, the video encoder 20 may generate encoded data associated with the slice. The encoded data associated with the slice may be referred to as a “coded slice.”

### DSC Video Encoder

FIG. 2A is a block diagram illustrating an example of the video encoder 20 that may implement techniques in accordance with aspects described in this disclosure. The video encoder 20 may be configured to perform some or all of the techniques of this disclosure. In some examples, the techniques described in this disclosure may be shared among the various components of the video encoder 20. In some examples, additionally or alternatively, a processor (not shown) may be configured to perform some or all of the techniques described in this disclosure.

For purposes of explanation, this disclosure describes the video encoder 20 in the context of DSC coding. However, the techniques of this disclosure may be applicable to other coding standards or methods.

In the example of FIG. 2A, the video encoder 20 includes a plurality of functional components. The functional components of the video encoder 20 include a color-space converter 105, a buffer, 110, a flatness detector 115, a rate controller 120, a predictor, quantizer, and reconstructor component 125, a line buffer 130, an indexed color history 135, an entropy encoder 140, a substream multiplexor 145, and a rate buffer 150. In other examples, the video encoder 20 may include more, fewer, or different functional components.

The color-space 105 converter may convert an input color-space to the color-space used in the coding implementation. For example, in one exemplary embodiment, the color-space of the input video data is in the red, green, and blue (RGB) color-space and the coding is implemented in the luminance Y, chrominance green Cg, and chrominance orange Co (YCgCo) color-space. The color-space conversion may be performed by method(s) including shifts and additions to the video data. It is noted that input video data in other color-spaces may be processed and conversions to other color-spaces may also be performed.

In related aspects, the video encoder 20 may include the buffer 110, the line buffer 130, and/or the rate buffer 150. For example, the buffer 110 may hold the color-space converted video data prior to its use by other portions of the video encoder 20. In another example, the video data may be stored in the RGB color-space and color-space conversion may be performed as needed, since the color-space converted data may require more bits.

The rate buffer 150 may function as part of the rate control mechanism in the video encoder 20, which will be described in greater detail below in connection with rate controller 120. The bits spent on encoding (i.e., the bits utilized to encode) each block of video data can vary highly substantially based on the properties (e.g., size, number of bits, etc.) of the block. The rate buffer 150 can smooth the rate variations in the compressed video (i.e., the output video stream). In some embodiments, a constant bit rate (CBR) buffer model is employed in which bits are removed from the buffer at a constant bit rate during transmission of data over a wired physical link. In the CBR buffer model, if the video encoder 20 adds too many bits to the bitstream, the number of bits in the rate buffer 150 may exceed the capacity of the rate buffer 150, causing overflow. On the other hand, the video encoder 20 should add bits at a sufficient rate in order to prevent underflow of the rate buffer 150.

On the video decoder side, the bits may be added to rate buffer 155 of the video decoder 30 (see FIG. 2B which is described in further detail below) at a constant bit rate, and the video decoder 30 may remove variable numbers of bits for each block. To ensure proper decoding, the rate buffer 155 of the video decoder 30 should not underflow or overflow during the decoding of the compressed bit stream.

In some embodiments, the buffer fullness (BF) can be defined based on a variable BufferCurrentSize representing the number of bits currently stored in the buffer and a variable BufferMaxSize representing a size (i.e., a capacity) of the rate buffer 150, i.e., the overall maximum number of bits that can be stored in the rate buffer 150. The “fullness” of the buffer (also referred to as buffer fullness (BF)) may be calculated as shown in Equation 1 below. BF represents a percentage of the capacity of a buffer being used for storage of bits at a particular point in time.

BF=((BufferCurrentSize*100)/BufferMaxSize) (Equation 1)

The flatness detector 115 can detect changes from complex (i.e., non-flat) areas in the video data to flat (i.e., simple or uniform) areas in the video data. The terms “complex” and “flat” will be used herein to generally refer to the difficulty for the video encoder 20 to encode the respective regions of the video data. Thus, the term complex as used herein generally describes a region of the video data as being complex for the video encoder 20 to encode and may, for example, include textured video data, high spatial frequency, and/or other features which are complex to encode. The term flat as used herein generally describes a region of the video data as being simple for the video encoder 20 to encoder and may, for example, include a smooth gradient in the video data, low spatial frequency, and/or other features which are simple to encode. The transitions between complex and flat regions may be used by the video encoder 20 to reduce quantization artifacts in the encoded video data. Specifically, the rate controller 120 and the predictor, quantizer, and reconstructor component 125 can reduce such quantization artifacts when the transitions from complex to flat regions are identified.

The rate controller 120 determines a set of coding parameters, e.g., a QP. The QP may be adjusted by the rate controller 120 based on the buffer fullness of the rate buffer 150 and image activity of the video data in order to maximize picture quality for a target bitrate which ensures that the rate buffer 150 does not overflow or underflow. The rate controller 120 also selects a particular coding option (e.g., a particular mode) for each block of the video data in order to achieve the optimal rate-distortion performance. The rate controller 120 minimizes the distortion of the reconstructed images such that the rate controller 120 satisfies the bit-rate constraint, i.e., the overall actual coding rate falls within the target bit rate.

The predictor, quantizer, and reconstructor component 125 may perform at least three encoding operations of the video encoder 20. The predictor, quantizer, and reconstructor component 125 may perform prediction in a number of different modes. One example prediction mode is a modified version of median-adaptive prediction. Median-adaptive prediction may be implemented by the lossless JPEG standard (JPEG-LS). The modified version of median-adaptive prediction which may be performed by the predictor, quantizer, and reconstructor component 125 may allow for parallel prediction of three consecutive sample values. Another example prediction mode is block prediction. In block prediction, samples are predicted from previously reconstructed pixels in the line above or to the left in the same line. In some embodiments, the video encoder 20 and the video decoder 30 may both perform an identical search on reconstructed pixels to determine the block prediction usages, and thus, no bits need to be sent in the block prediction mode. In other embodiments, the video encoder 20 may perform the search and signal block prediction vectors in the bitstream, such that the video decoder 30 need not perform a separate search. A midpoint prediction mode may also be implemented in which samples are predicted using the midpoint of the component range. The midpoint prediction mode may enable bounding of the number of bits required for the compressed video in even the worst-case sample.

The predictor, quantizer, and reconstructor component 125 also performs quantization. For example, quantization may be performed via a power-of-2 quantizer which may be implemented using a shifter. It is noted that other quantization techniques may be implemented in lieu of the power-of-2 quantizer. The quantization performed by the predictor, quantizer, and reconstructor component 125 may be based on the QP determined by the rate controller 120. Finally, the predictor, quantizer, and reconstructor component 125 also performs reconstruction which includes adding the inverse quantized residual to the predicted value and ensuring that the result does not fall outside of the valid range of sample values.

It is noted that the above-described example approaches to prediction, quantization, and reconstruction performed by the predictor, quantizer, and reconstructor component 125 are merely illustrative and that other approaches may be implemented. It is also noted that the predictor, quantizer, and reconstructor component 125 may include subcomponent(s) for performing the prediction, the quantization, and/or the reconstruction. It is further noted that the prediction, the quantization, and/or the reconstruction may be performed by several separate encoder components in lieu of the predictor, quantizer, and reconstructor component 125.

The line buffer 130 holds the output from the predictor, quantizer, and reconstructor component 125 so that the predictor, quantizer, and reconstructor component 125 and the indexed color history 135 can use the buffered video data. The indexed color history 135 stores recently used pixel values. These recently used pixel values can be referenced directly by the video encoder 20 via a dedicated syntax.

The entropy encoder 140 encodes the prediction residuals and any other data (e.g., indices identified by the predictor, quantizer, and reconstructor component 125) received from the predictor, quantizer, and reconstructor component 125 based on the indexed color history 135 and the flatness transitions identified by the flatness detector 115. In some examples, the entropy encoder 140 may encode three samples per clock per substream encoder. The substream multiplexor 145 may multiplex the bitstream based on a headerless packet multiplexing scheme. This allows the video decoder 30 to run three entropy decoders in parallel, facilitating the decoding of three pixels per clock. The substream multiplexor 145 may optimize the packet order so that the packets can be efficiently decoded by the video decoder 30. It is noted that different approaches to entropy coding may be implemented, which may facilitate the decoding of power-of-2 pixels per clock (e.g., 2 pixels/clock or 4 pixels/clock).

### DSC Video Decoder

FIG. 2B is a block diagram illustrating an example of the video decoder 30 that may implement techniques in accordance with aspects described in this disclosure. The video decoder 30 may be configured to perform some or all of the techniques of this disclosure. In some examples, the techniques described in this disclosure may be shared among the various components of the video decoder 30. In some examples, additionally or alternatively, a processor (not shown) may be configured to perform some or all of the techniques described in this disclosure.

For purposes of explanation, this disclosure describes the video decoder 30 in the context of DSC coding. However, the techniques of this disclosure may be applicable to other coding standards or methods.

In the example of FIG. 2B, the video decoder 30 includes a plurality of functional components. The functional components of the video decoder 30 include a rate buffer 155, a substream demultiplexor 160, an entropy decoder 165, a rate controller 170, a predictor, quantizer, and reconstructor component 175, an indexed color history 180, a line buffer 185, and a color-space converter 190. The illustrated components of the video decoder 30 are analogous to the corresponding components described above in connection with the video encoder 20 in FIG. 2A. As such, each of the components of the video decoder 30 may operate in a similar fashion to the corresponding components of the video encoder 20 as described above.

### Slices in DSC

As noted above, a slice generally refers to a spatially distinct region in an image or a frame that can be decoded independently without using the information from the rest of the regions in the image or frame. Each image or video frame may be encoded in a single slice or each image or video frame may be encoded in several slices. In DSC, the number of bits allocated to encode each slice may be substantially constant.

### Ordering of Prefixes and Suffixes to Increase Throughput

VLC may be used to code video data in DSC. Numerous VLC techniques divide each symbol into a prefix and a suffix. The prefix is usually coded as a unary code. In unary coding, a code may contain a certain number of 1's before a 0 (e.g., 0, 10, 110, 1110, 11110, 11110, etc.). Or a code may contain a certain number 0's before a 1 (e.g., 1, 01, 001, 0001, 00001, etc.). In some cases, the number of leading 1's (or 0's) can be translated into the length of the suffix or be a part of a formula for decoding, for example, of the suffix.

The length of the suffix may be fixed (e.g., Golomb Rice codes) or may depend on the prefix value (e.g., exponential Golomb codes). The prefix value may specify the length of the suffix. For example, a prefix can indicate the length of a suffix, where the suffix indicates the value of a color component of a pixel. A color component can include a luminance component and one or more chrominance components. For instance, in YCgCo color model (or YCoCg color model), a pixel is represented by a luminance component (Y), a chrominance green component (Cg), and a chrominance orange component (Co). A DSC bitstream may include a prefix for a color component of each pixel and a suffix for that color component. For example, a block may be coded in units of 16 pixels, and the DSC bitstream can include a prefix and a suffix for the Y component of each pixel, a prefix and a suffix for the Cg component of each pixel, and a prefix and a suffix for the Co component of each pixel. The order of the prefixes and suffixes can be arranged such that the prefixes and the suffixes alternate. For example, the prefix and the suffix of a color component (e.g., Y component) of the first pixel are encoded first, then the prefix and the suffix of the same color component of the second pixel is encoded, and so on. All prefix and suffix pairs for the same color component can be grouped together. For instance, the prefix and suffix pairs for the Y component are grouped together, then the prefix and suffix pairs for the Cg component, and then the prefix and suffix pairs for the Co component, as shown in FIG. 3.

However, alternating the prefix and the suffix in this manner may make it difficult to meet throughput requirements because each prefix and suffix pair is decoded in sequence. The decoder may not have information on where the second prefix is located in the bitstream until the decoder decodes the first prefix and then decodes the first suffix based on the length indicated by the first prefix. This can create a cascading path which makes it difficult to meet timing, thereby decreasing the throughput. Moreover, in some cases, since the prefix is typically coded using a unary code, the length of the prefix may be variable. Therefore, a decoder should parse the prefix before the decoder can start parsing the suffix, since the starting position of the suffix depends on the length of the prefix.

In order to address these and other challenges, the techniques of the present disclosure according to certain aspects can reorder the prefixes and suffixes representing pixels to increase throughput, for example, by placing all prefixes in front of all suffixes. In one example, all prefixes for the Y component of the pixels in a block precede all suffixes for the Y component of the pixels in the block. Placing all prefixes before all suffixes can make the length information of all suffixes available after decoding all the prefixes. The decoder then can determine the positions of all suffixes after decoding all the prefixes, and the decoding of the suffixes can proceed in parallel. The length of some suffixes may be available before the length of other suffixes since the length of a suffix is available as soon as the corresponding prefix is decoded. For instance, after decoding the first prefix that indicates the length of the first suffix, the decoder can proceed with the decoding of the first suffix, while the length of the second suffix may not be available because the decoder has not yet decoded the second prefix that indicates the length of the second suffix. The decoder may decode suffixes for which the length is known as soon as the length is available, or the decoder may wait to decode the suffixes together after the length of all suffixes is obtained, depending on the embodiment. In this manner, the decoding of suffixes can proceed at least in part in parallel. Moreover, making the suffix length information available at the beginning can allow the decoder to determine the positions of the next set of prefixes after decoding all the prefixes since the decoder can shift down the bitstream by the length of all the suffixes. In this manner, making the prefixes available prior to the suffixes can make the decoding process more efficient since the suffixes can be decoded in parallel and can increase throughput.

Certain details relating to ordering of prefixes and suffixes in VLC are explained below, for example, in connection with exemplary embodiments. All features and/or embodiments described in this disclosure may be implemented separately or in combination. As used described herein, the term “video coder” refers generically to both video encoders and video decoders. In this disclosure, the terms “video coding” or “coding” may refer generically to video encoding and video decoding. In addition to video encoders and video decoders, the aspects described in the present application may be extended to other related devices such as transcoders (e.g., devices that can decode a bitstream and re-encode another bitstream) and media aware network elements (MANES) such as middleboxes (e.g., devices that can modify, transform, and/or otherwise manipulate a bitstream).

### Alternating Prefixes and Suffixes

As mentioned above, in one implementation of a DSC system, encoding may be performed in units of blocks of, for example, 16 pixels. For some modes, VLC may be used, which can make it difficult to meet the throughput requirements of the design. Each block of 16 pixels may be encoded and packed into a bitstream, with header information first, followed by the encoded Y, Co, Cg components, as shown in FIG. 3. For example, a bitstream 310 in FIG. 3 includes a header, information for the block being coded, Y components for the 16 pixels included in the block, Co components for the 16 pixels, and Cg components for the 16 pixels. In some embodiments, Cg components may be coded prior to Co components. The bitstream 320 in FIG. 3 shows a detailed view of a portion of the bitstream 310, for example, for a specific color component (e.g., Y component). A specific color component can include 16 pairs of alternating prefix and suffix as shown in FIG. 3. Each of the Y, Co, and Cg components may include 16 pairs of alternating prefix and suffix.

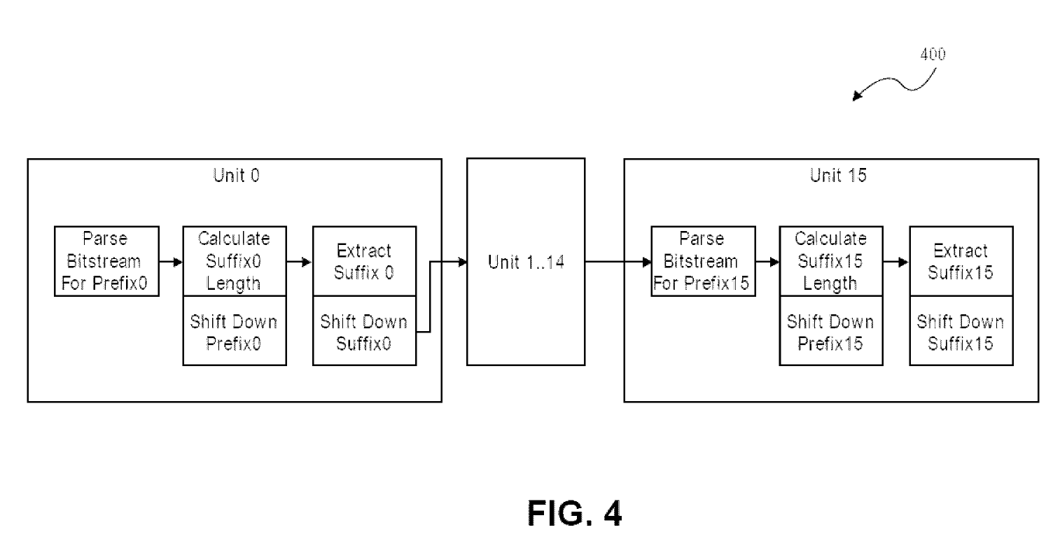

In one hardware implementation, to decode the 16 prefixes and 16 suffixes, 16 units of parser are cascaded, for example, as shown in FIG. 4. Each unit first parses the bitstream to retrieve the variable length prefix, which then provides information on the starting position and length of the suffix. In some embodiments, a unit may refer to a piece of hardware logic that performs the parsing of 1 prefix and 1 suffix. The input bitstream is then shifted down for the next unit to be parsed. This cascading hardware creates a very long timing path, thereby restricting the throughput.

### Grouping Pixels

To reduce the number of cascading hardware units, the compression system may group multiple samples (e.g., either in the spatial or transform domain) into a single group. For example, if the 16 sample block is coded using four 4×1, transforms, the block may be divided into 4 groups. Each group may contain 4 transform coefficients representing the same frequency from the four different transform blocks. Other groupings, such as, for example, non-uniform grouping, are possible as well.

A pixel generally has 3 components (e.g., YCrCb or YCbCr). Depending on the compression algorithm, compression can be performed independently on each component. For instance, compression can be performed on one type of component independently of other types of components (e.g., compress only the Y component), instead of compressing the whole pixel (e.g., compress all components together). In certain embodiments, the data of a particular type of component may be referred to as samples.

It is noted that a block of 16 pixels is just one example. Longer or shorter blocks may be used as well. For a group containing N samples, there may be a single prefix and N suffixes. The single prefix may represent the length of each one of the N suffixes. In one embodiment, the prefix is differentially coded with respect to a previous prefix value. This grouping reduces the number of cascading units, and shortens the critical timing path. The technique described below allows further pipelining of this critical timing path.

In accordance with one or more aspects of the present disclosure, there is provided a VLC technique that involves reordering the prefix and suffix information. The bitstream may be reordered by moving the prefix terms together, followed by the suffix terms.

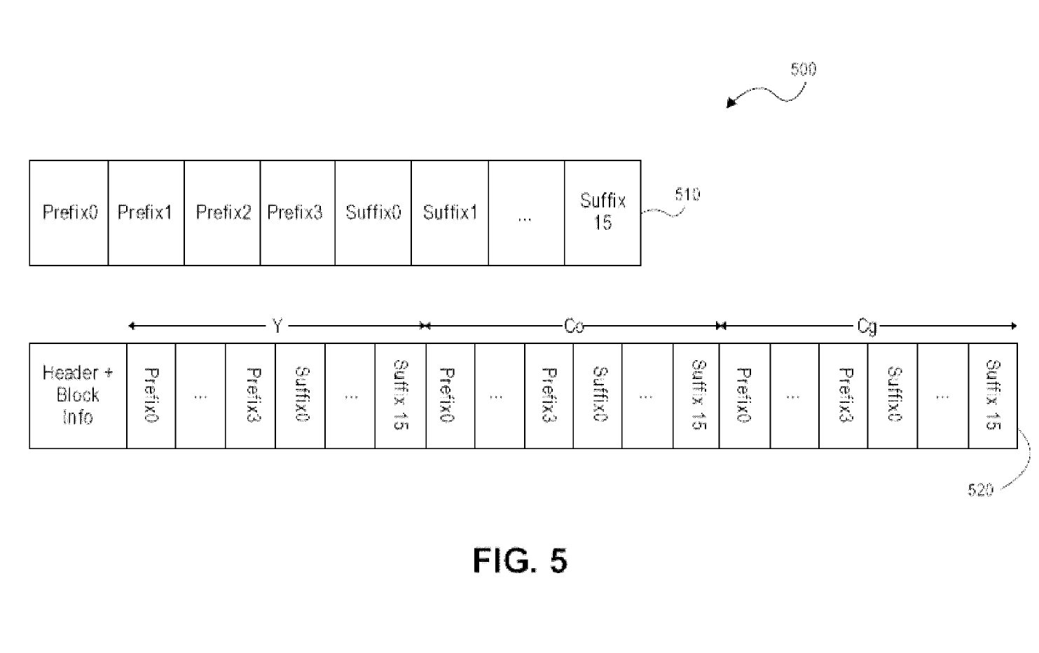

In one implementation, for each component, all of the prefix terms may be moved together, followed by all of the suffix terms for bitstream packing In one illustrative example, shown in FIG. 5, the 4 prefix terms may be grouped together followed by the 16 suffix terms. This reduces the long cascading path of decoding multiple prefixes and suffixes. It also allows more pipelining in hardware for the suffix decoding.

(1) The 4 prefix terms may be moved to the front of the bitstream to be decoded before the suffix terms. Each prefix may contain information regarding the length of a group of suffixes. The 4 prefixes together may contain all the information required to calculate the total length of the 16 suffixes, as shown in FIG. 5. For example, the bitstream 510 in FIG. 5 shows Prefix 0 through Prefix 3 and Suffix 0 through Suffix 15. Prefix 0 indicates the length of Suffix 0-3, Prefix 1 indicates the length of Suffix 4-7, Prefix 2 indicates the length of Suffix 8-11, and Prefix 3 indicates the length of Suffix 12-15. As described above, the pixels or samples in a block can be divided into multiple groups, and each group can have one shared prefix that indicates the length of all the suffixes for the pixels or samples belonging to the group. In other embodiments, one prefix can indicate the length of more than or less than 4 suffixes. Or in some embodiments, one prefix can indicate the length of one suffix. A prefix can indicate the length of one or multiple suffixes, and the length of all suffixes in one group would be the same and can be decoded from one prefix. The length or size of a prefix may be fixed, but it can also be variable, depending on the embodiment.

(2) To parse the prefixes for 16 pixels, 3 clocks may be used, one clock for each of the components of Y, Co, and Cg, as shown in FIG. 5. The bitstream 520 can include a header, block information, 4 prefixes and 16 suffixes for the Y component of the 16 pixels in the block, 4 prefixes and 16 suffixes for the Co component of the 16 pixels and 4 prefixes and 16 suffixes for the Cg component of the 16 pixels. The bitstream 510 can be a detailed view of a portion of the bitstream 520, for example, for a specific color component (e.g., Y component). One clock can be used to parse 4 prefixes of a specific color component. This leaves one clock at the beginning to parse the header and other block information. This technique can yield a throughput of 16 pixels per 4 clocks, or an average of 4 pixels per clock.

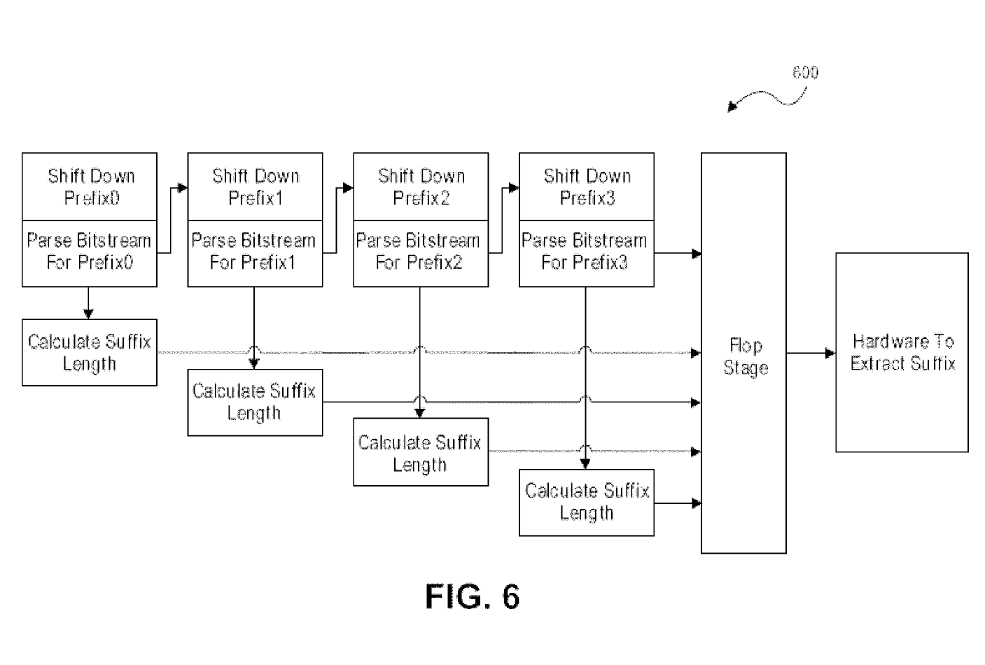

(3) FIG. 6 is a block diagram illustrating an example of hardware implementation for decoding a bitstream used in VLC for ordering prefixes and suffixes in accordance with aspects described in this disclosure. A block in hardware may refer to a group of logic that is responsible for decoding a particular number of prefixes in one clock. In the example of FIG. 6, a block may be responsible for decoding the 4 prefixes in one clock. For example, the decoder can shift down to the position of Prefix 0 and parse the bitstream for Prefix 0, shift down to the position of Prefix 1 and parse the bitstream for Prefix 1, shift down to the position of Prefix 2 and parse the bitstream for Prefix 2, then shift down to the position of Prefix 3 and parse the bitstream for Prefix 3. This can occur in one clock. It may also calculate the total size of the 16 suffixes based on the parsed prefixes, shift the bitstream down, and send all the 16 suffixes to the next block. The actual parsing of the suffixes may be pipelined to the following clocks, as shown in FIG. 6. For instance, the actual parsing and/or processing of the suffixes can be pushed to the next clock at the flop stage, for example, using hardware storage flip-flop that stores the suffixes. The example of FIG. 6 shows that Prefix 0 through Prefix 3 are decoded first in one clock and the 16 suffixes are decoded subsequently over one or more clocks. However, in certain embodiments, the suffixe(s) for which a prefix indicates the length can be decoded as soon as the prefix is decoded. For instance, Suffix 0 through Suffix 3 can be decoded as soon as Prefix 0 is decoded since Prefix 0 indicates the length of Suffix 0 through Suffix 3.

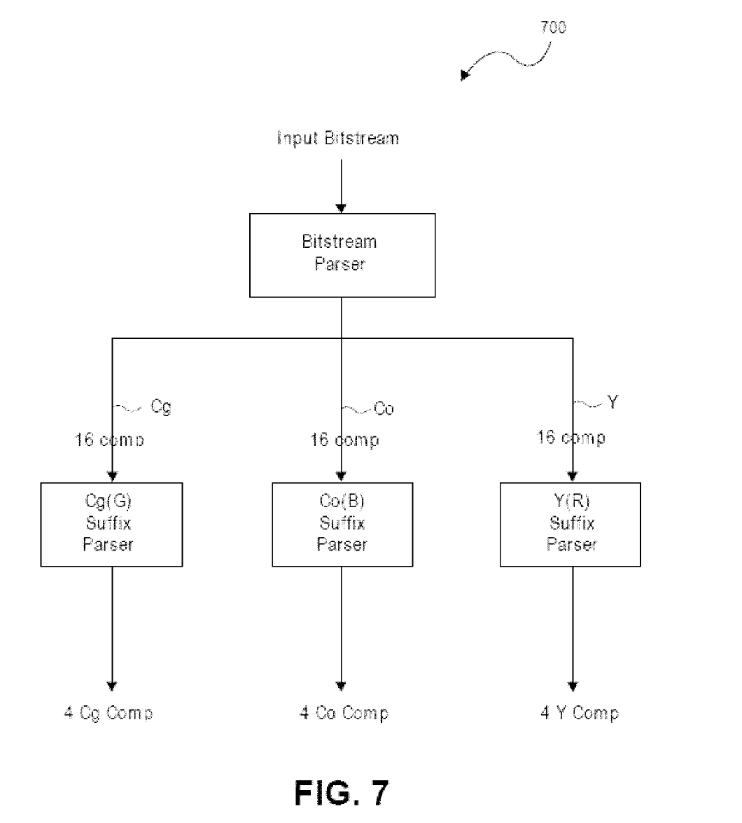

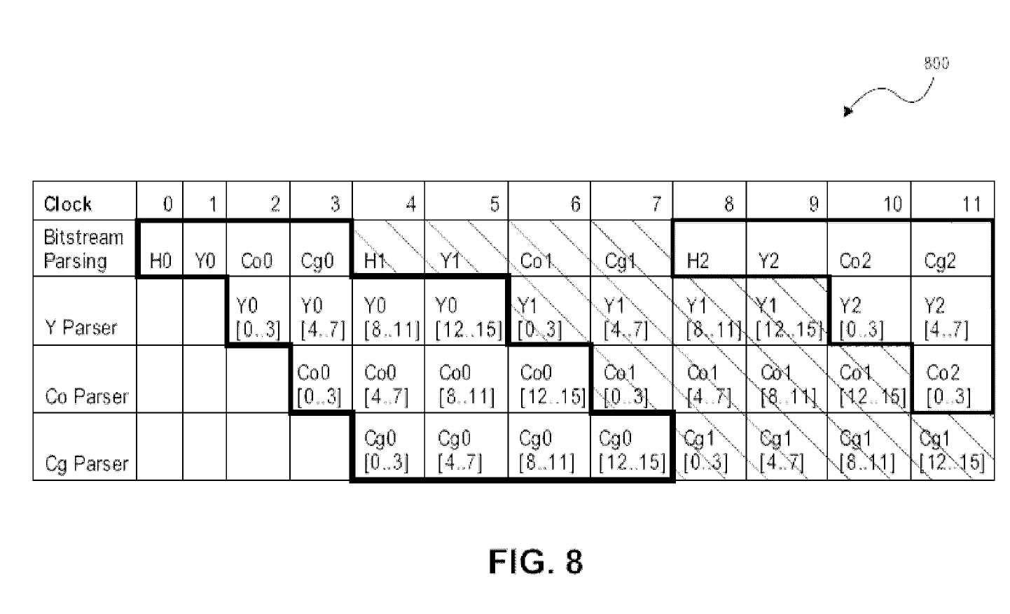

(4) For suffix parsing, 3 suffix parsers can be used to parse each component (e.g., Y, Co, Cg), as shown in FIG. 7. FIG. 7 is a block diagram illustrating an example of hardware implementation for decoding a bitstream used in VLC for ordering prefixes and suffixes in accordance with aspects described in this disclosure. For instance, the parser can be instantiated for each color component. FIG. 7 shows a Cg (G) suffix parser, a Co (B) suffix parser, and a Y (R) suffix parser. As mentioned above, a pixel can generally contain 3 components (e.g., YCoCg, YCrCb, etc.). In the example of FIG. 7, compression is performed in groups of 16 pixels and independently for each component. Accordingly, there can be a parser for each component. There can be 16 Cg components for the Cg suffix parser to process for a block, 16 Co components for the Co suffix parser to process for the block, and 16 Y components for the Y suffix parser to process for the block. To have an average throughput of 4 pixels per clock, each suffix parser can parse 4 suffixes per clock, for example, as shown in FIG. 8. For instance, the Cg (G) suffix parser processes 4 Cg components in one clock, the Co (B) suffix parser processes 4 Co components in one clock, and the Y (R) suffix parser processes 4 Y components in one clock. For example, each parser (e.g., the Cg suffix parser, the CO suffix parser, the Y suffix parser) would take 16 samples as input every 4 clocks and output 4 samples per clock.

In the examples of FIG. 6 and FIG. 7, one prefix decodes into the length of 4 suffixes. The suffix parser can shift the input bitstream to obtain the 4 suffixes. If Prefix 0 indicates that Suffix 0 through Suffix 3 have a length of 8 bits each, the suffix parser shifts the input bitstream by 8 bits each time in order to obtain the 4 components of 8 bits. This can be done for each suffix parser. For instance, the Cg (G) suffix parser obtains the length of a group of Cg suffixes and shifts the input bitstream by the indicated length in order to obtain the values of the Cg suffixes in the group. Similarly, the Co (B) suffix parser obtains the length of a group of Co suffixes and shifts the input bitstream by the indicated length in order to obtain the values of the Co suffixes in the group. The Y (R) suffix parser can perform a similar process with respect to Y suffixes.

In the example of FIG. 7, the suffix parsers are described in terms of Cg components, Co components, and Y components for the case where a pixel is in the YCoCg format. However, pixels could be represented using many different formats, such as RGB. When pixels are in a format other than YCoCg, similar separate processing can occur for the suffixes of each component. For instance, for pixels coded using RGB, a suffix parser can be created for the R component, a suffix parser can be created for the G component, and a suffix parser can be created for the B component. In the example of FIG. 7, the parenthetical letters following the Cg suffix parser, the Co suffix parser, and the Y suffix parser above (e.g., “(G)”, “(B)”, “(R)”) indicate that the suffix parsers could each process G, B, and R components, respectively, if pixels are coded using the RGB color model. FIG. 7 is provided for illustrative purposes, and the techniques described in the disclosure are not limited to a specific color model or format.

FIG. 8 is a block diagram illustrating an example of decoding a bitstream used in VLC for ordering prefixes and suffixes in accordance with aspects described in this disclosure. In the example of FIG. 8, at clock 0, the decoder parses the header and/or block information for block 0. At clock 1, the decoder parses the Y prefixes for block 0. At clock 2, the decoder parses the Co prefixes for block 0. At clock 2, the decoder also parses Y suffixes 0-3 for block 0. The decoder can instantiate a parser for parsing Y components and use the parser to parse the Y suffixes. At clock 3, the decoder parses the Cg prefixes for block 0. At clock 3, the decoder also parses Y suffixes 4-7 for block 0. At clock 3, the decoder also parses Co suffixes 0-3 for block 0. The decoder can instantiate a parser for parsing Co components and use the parser to parse the Co suffixes. At clock 4, the decoder parses the header and/or block information for block 1. At clock 4, the decoder also parses the Y suffixes 8-11 for block 0 and the Co suffixes 4-7 for block 0. At clock 4, the decoder also parses Cg suffixes 0-3 for block 0. The decoder can instantiate a parser for parsing Cg components and use the parser to parse the Cg suffixes. Similarly, for clocks 5 through 11, the decoder parses the prefixes for different blocks in sequence and then parses the suffixes for different color components in parallel using separate parsers. In this way, the decoding of different color components can occur in parallel by decoding the prefixes for the color components prior to the suffixes.

Ordering all the prefixes of a color component prior to all the suffixes of the color component allows the decoder to determine the length or size of all the suffixes after decoding the prefixes, instead of having to wait until each prefix-suffix pair is decoded. Because the decoder knows the length of all the suffixes after decoding the prefixes, the decoder can proceed to parse all the suffixes in parallel. Also, because the length of all the suffixes of a color component (e.g., Y component) can be known after decoding the prefixes for that color component, the decoder can determine the position of the prefixes for the next color component (e.g., Co component) and can proceed with decoding of the prefixes and suffixes for the next color component. By using separate parsers for the different color components, the parsing of the different color components can proceed substantially in parallel, thereby increasing throughput.

Although aspects of the present VLC technique are described with respect to a display stream compression system that uses a block size of 16, it should be noted that one or more of such aspects may be applicable to other VLC coding schemes in which a block is divided into multiple groups and where each group shares a single prefix and multiple suffixes. It is noted that the suffixes in a single group may have the same length that can be derived from the prefix value.

### Method of Ordering Prefixes and Suffixes in VLC

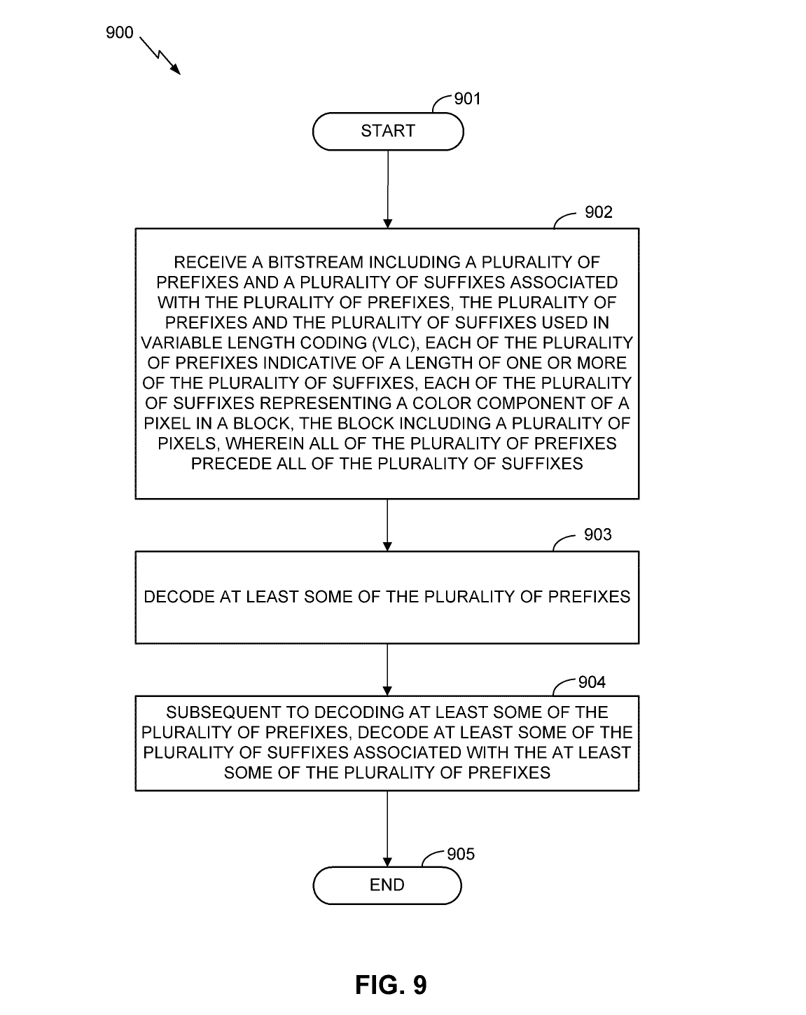

FIG. 9 is a flowchart illustrating a process 900 for coding video data, according to an embodiment of the present disclosure. The process relates to ordering prefixes and suffixes in VLC. The blocks of the process 900 may be performed by a video encoder (e.g., the video encoder 20 in FIG. 2A), a video decoder (e.g., the video decoder 90 in FIG. 2B), or component(s) thereof. For illustrative purposes, the process 900 is described as performed by a video coder (also simply referred to as coder), which may be the video encoder 20, the video decoder 90, or another component. All embodiments described with respect to FIG. 9 may be implemented separately, or in combination with one another. Certain details relating to the process 900 are explained above.

The process starts at block 901. The coder can include a memory for storing video data. At block 902, the coder (e.g., the decoder) receives a bitstream including a plurality of prefixes and a plurality of suffixes associated with the plurality of prefixes. The plurality of prefixes and the plurality of suffixes may be used in VLC. Each of the plurality of prefixes can be indicative of the length of one or more of the plurality of suffixes. Each of the plurality of suffixes can represent a color component of a pixel in a block of the video data. The block may include a plurality of pixels. All of the plurality of prefixes may precede all of the plurality of suffixes.

In some embodiments, the color component is a luminance component or a chrominance component. For example, the luminance component is a Y component, and the chrominance component is a Co component or a Cg component (for example, used in YCoCg color model). In certain embodiments, the bitstream includes a first set of prefixes and a first set of suffixes representing the Y components of the pixels in the block, a second set of prefixes and a second set of suffixes representing the Co components of the pixels in the block, and a third set of prefixes and a third set of suffixes representing the Cg components of the pixels in the block. The first set of prefixes may precede the first set of suffixes, the second set of prefixes may precede the second set of suffixes, and the third set of prefixes may precede the third set of suffixes. In one embodiment, the plurality of pixels in the block are divided into groups each comprising two or more pixels, and each of the plurality of prefixes indicates the length of suffixes associated with pixels belonging to each group.

At block 903, the coder decodes at least some of the plurality of prefixes. In some embodiments, the coder may decode the first set of prefixes prior to the first set of suffixes, decode the second set of prefixes prior to the second set of suffixes, and decode the third set of prefixes prior to the third set of suffixes. The coder may parse the first set of prefixes, the second set of prefixes, and the third set of prefixes in sequence. For example, the coder parses the first set of prefixes in one clock, parses the second set of prefixes in one clock, and parses the third set of prefixes in one clock.

At block 904, subsequent to decoding at least some of the plurality of prefixes, the coder decodes at least some of the plurality of suffixes associated with the at least some of the plurality of prefixes. In certain embodiments, the coder parses the first set of suffixes using a first parser, parses the second set of suffixes using a second parser, and parses the third set of suffixes using a third parser. The parsing of the first set of suffixes, the parsing of the second set of suffixes, and the parsing of the third set of suffixes can occur at least in part in parallel. For example, the parsing of the three sets of suffixes occur in parallel but may be staggered by one clock as shown in FIG. 8. This may be due to parsing the three sets of prefixes in sequence. In some embodiments, the coder parses the first set of suffixes in two or more clocks, parses the second set of suffixes in two or more clocks, and parses the third set of suffixes in two or more clocks.

In certain embodiments, an encoder can receive video data to be coded and encode a video unit using a plurality of prefixes and a plurality of suffixes associated with the plurality of prefixes. The plurality of prefixes and the plurality of suffixes may be used in VLC. Each of the plurality of prefixes may be indicative of the length of one or more of the plurality of suffixes. Each of the plurality of suffixes may represent a color component of a pixel in a block of the video data. The block can include a plurality of pixels. All of the plurality of prefixes may precede all of the plurality of suffixes. The encoder can send the coded video unit in a bitstream, for example, in a DSC bitstream.

In some embodiments, the plurality of pixels in the block are divided into groups each comprising two or more pixels, and each of the plurality of prefixes indicates the length of suffixes associated with pixels belonging to each group. The color component may be a luminance component or a chrominance component. The luminance component can be a Y component, and the chrominance component can be a Co component or a Cg component. In certain embodiments, the bitstream includes a first set of prefixes and a first set of suffixes representing the Y components of the pixels in the block, a second set of prefixes and a second set of suffixes representing the Co components of the pixels in the block, and a third set of prefixes and a third set of suffixes representing the Cg components of the pixels in the block. The first set of prefixes may precede the first set of suffixes, the second set of prefixes may precede the second set of suffixes, and the third set of prefixes may precede the third set of suffixes.

The process 900 ends at block 905. Blocks may be added and/or omitted in the process 900, depending on the embodiment, and blocks of the process 900 may be performed in different orders, depending on the embodiment.

Any features and/or embodiments described in this disclosure may be implemented separately or in any combination thereof. For example, any features and/or embodiments described in connection with FIGS. 1-8 and other parts of the disclosure may be implemented in any combination with any features and/or embodiments described in connection with FIG. 9, and vice versa. The embodiments of the present disclosure are not limited to or by the example shown in FIG. 9, and other variations may be implemented without departing from the spirit of this disclosure.

### Other Considerations

Information and signals disclosed herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, and algorithm steps described in connection with the embodiments disclosed herein may be implemented as electronic hardware, computer software, or combinations of both. To clearly illustrate this interchangeability of hardware and software, various illustrative components, blocks, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The techniques described herein may be implemented in hardware, software, firmware, or any combination thereof. Such techniques may be implemented in any of a variety of devices such as general purposes computers, wireless communication device handsets, or integrated circuit devices having multiple uses including application in wireless communication device handsets and other devices. Any features described as devices or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software or hardware configured for encoding and decoding, or incorporated in a combined video encoder-decoder (CODEC). Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, or units are described in this disclosure to emphasize functional aspects of devices configured to perform the disclosed techniques, but do not necessarily require realization by different hardware units. Rather, as described above, various units may be combined in a codec hardware unit or provided by a collection of inter-operative hardware units, including one or more processors as described above, in conjunction with suitable software and/or firmware.

Although the foregoing has been described in connection with various different embodiments, features or elements from one embodiment may be combined with other embodiments without departing from the teachings of this disclosure. However, the combinations of features between the respective embodiments are not necessarily limited thereto. Various embodiments of the disclosure have been described. These and other embodiments are within the scope of the following claims.

What is claimed is:

1. An apparatus for decoding video data, comprising:
a memory for storing the video data; and
a hardware processor in communication with the memory and configured to:
receive a bitstream including a plurality of prefixes and a plurality of suffixes associated with the plurality of prefixes, the plurality of prefixes and the plurality of suffixes used in variable length coding (VLC), each of the plurality of prefixes indicative of a length of one or more of the plurality of suffixes, each of the plurality of suffixes representing a color component of a pixel in a block of the video data, the block including a plurality of pixels, wherein all of the plurality of prefixes precede all of the plurality of suffixes;
decode at least some of the plurality of prefixes; and
subsequent to decoding at least some of the plurality of prefixes, decode at least some of the plurality of suffixes associated with the at least some of the plurality of prefixes.

2. The apparatus of claim 1, wherein the plurality of pixels in the block are divided into groups each comprising two or more pixels, and wherein each of the plurality of prefixes indicates a length of suffixes associated with pixels belonging to each group.

3. The apparatus of claim 1, wherein the color component is a luminance component or a chrominance component.

4. The apparatus of claim 3, wherein the luminance component is a Y component and the chrominance component is a Co component or a Cg component.

5. The apparatus of claim 4, wherein the bitstream includes:
a first set of prefixes and a first set of suffixes representing the Y components of the pixels in the block;
a second set of prefixes and a second set of suffixes representing the Co components of the pixels in the block; and
a third set of prefixes and a third set of suffixes representing the Cg components of the pixels in the block.

6. The apparatus of claim 5, wherein:
the first set of prefixes precede the first set of suffixes, the second set of prefixes precede the second set of suffixes, and the third set of prefixes precede the third set of suffixes; and
the processor is further configured to:
decode the first set of prefixes prior to the first set of suffixes;
decode the second set of prefixes prior to the second set of suffixes; and
decode the third set of prefixes prior to the third set of suffixes.

7. The apparatus of claim 6, wherein the processor is further configured to:
parse the first set of prefixes, the second set of prefixes, and the third set of prefixes in sequence.

8. The apparatus of claim 7, wherein the processor is configured to:
parse the first set of prefixes in one clock;
parse the second set of prefixes in one clock; and
parse the third set of prefixes in one clock.

9. The apparatus of claim 8, wherein the processor is further configured to:
parse the first set of suffixes using a first parser;
parse the second set of suffixes using a second parser; and
parse the third set of suffixes using a third parser,
wherein the parsing of the first set of suffixes, the parsing of the second set of suffixes, and the parsing of the third set of suffixes occur at least in part in parallel.

10. The apparatus of claim 9, wherein the processor is further configured to:
parse the first set of suffixes in two or more clocks;
parse the second set of suffixes in two or more clocks; and
parse the third set of suffixes in two or more clocks.

11. The apparatus of claim 1, wherein the apparatus comprises one or more of: a desktop computer, a notebook computer, a laptop computer, a tablet computer, a set-top box, a telephone handset, a smart phone, a wireless communication device, a smart pad, a television, a camera, a display device, a digital media player, a video gaming console, or a video streaming device.

12. A method of coding video data, comprising:
storing the video data;
receiving a bitstream including a plurality of prefixes and a plurality of suffixes associated with the plurality of prefixes, the plurality of prefixes and the plurality of suffixes used in variable length coding (VLC), each of the plurality of prefixes indicative of a length of one or more of the plurality of suffixes, each of the plurality of suffixes representing a color component of a pixel in a block, the block including a plurality of pixels, wherein all of the plurality of prefixes precede all of the plurality of suffixes;
decoding the plurality of prefixes; and
subsequent to decoding the plurality of prefixes, decoding the plurality of suffixes.

13. The method of claim 12, wherein the plurality of pixels in the block are divided into groups each comprising two or more pixels, and wherein each of the plurality of prefixes indicates a length of suffixes associated with pixels belonging to each group.

14. The method of claim 12, wherein the color component is a luminance component or a chrominance component.

15. The method of claim 14, wherein the luminance component is a Y component and the chrominance component is a Co component or a Cg component.

16. The method of claim 15, wherein the bitstream includes:
a first set of prefixes and a first set of suffixes representing the Y components of the pixels in the block;
a second set of prefixes and a second set of suffixes representing the Co components of the pixels in the block; and
a third set of prefixes and a third set of suffixes representing the Cg components of the pixels in the block.

17. The apparatus of claim 16, wherein:
the first set of prefixes precede the first set of suffixes, the second set of prefixes precede the second set of suffixes, and the third set of prefixes precede the third set of suffixes; and
the method further comprises:
decoding the first set of prefixes prior to the first set of suffixes;
decoding the second set of prefixes prior to the second set of suffixes; and
decoding the third set of prefixes prior to the third set of suffixes.

18. The method of claim 17, further comprising:
parsing the first set of prefixes, the second set of prefixes, and the third set of prefixes in sequence.

19. The method of claim 18, further comprising:
parsing the first set of prefixes in one clock;
parsing the second set of prefixes in one clock; and
parsing the third set of prefixes in one clock.

20. The method of claim 19, further comprising:
parsing the first set of suffixes using a first parser;
parsing the second set of suffixes using a second parser; and
parsing the third set of suffixes using a third parser,
wherein the parsing of the first set of suffixes, the parsing of the second set of suffixes, and the parsing of the third set of suffixes occur at least in part in parallel.

21. The method of claim 20, further comprising:
parsing the first set of suffixes in two or more clocks;
parsing the second set of suffixes in two or more clocks; and
parsing the third set of suffixes in two or more clocks.

22. An apparatus for coding video information, comprising:
means for storing the video data;
means for receiving a bitstream including a plurality of prefixes and a plurality of suffixes associated with the plurality of prefixes, the plurality of prefixes and the plurality of suffixes used in variable length coding (VLC), each of the plurality of prefixes indicative of a length of one or more of the plurality of suffixes, each of the plurality of suffixes representing a color component of a pixel in a block, the block including a plurality of pixels, wherein all of the plurality of prefixes precede all of the plurality of suffixes;
means for decoding the plurality of prefixes; and
means for decoding the plurality of suffixes, subsequent to decoding the plurality of prefixes.

23. An apparatus for encoding video data, comprising:
a memory for storing the video data; and
a hardware processor in communication with the memory and configured to:
receive the video data to be coded;
encode a video unit using a plurality of prefixes and a plurality of suffixes associated with the plurality of prefixes, the plurality of prefixes and the plurality of suffixes used in variable length coding (VLC), each of the plurality of prefixes indicative of a length of one or more of the plurality of suffixes, each of the plurality of suffixes representing a color component of a pixel in a block of the video data, the block including a plurality of pixels, wherein all of the plurality of prefixes precede all of the plurality of suffixes; and
send the coded video unit in a bitstream.

24. The apparatus of claim 23, wherein the plurality of pixels in the block are divided into groups each comprising two or more pixels, and wherein each of the plurality of prefixes indicates a length of suffixes associated with pixels belonging to each group.

25. The apparatus of claim 23, wherein the color component is a luminance component or a chrominance component.

26. The apparatus of claim 25, wherein the luminance component is a Y component and the chrominance component is a Co component or a Cg component.

27. The apparatus of claim 26, wherein the bitstream includes:
a first set of prefixes and a first set of suffixes representing the Y components of the pixels in the block;
a second set of prefixes and a second set of suffixes representing the Co components of the pixels in the block; and
a third set of prefixes and a third set of suffixes representing the Cg components of the pixels in the block,
wherein the first set of prefixes precede the first set of suffixes, the second set of prefixes precede the second set of suffixes, and the third set of prefixes precede the third set of suffixes.
